(19) United States
(12) Patent Application Publication
(10) Pub. No.: US 2008/0297626 A1
(43) Pub. Date: Dec. 4, 2008

(54) IMAGING DEVICE

(76) Inventor: Susumu Hashimoto, Nagoya (JP)

Correspondence Address: OSTROLENK FABER GERB & SOFFEN, 1180 AVENUE OF THE AMERICAS, NEW YORK, NY, 100368403, US

(21) Appl. No.: 12/127,445

(22) Filed: May 27, 2008

(30) Foreign Application Priority Data
May 30, 2007 (JP) 2007-143595

(51) Int. Cl. H04N 5/262

(52) U.S. Cl. 348/240.99; 348/E05.051

(57) ABSTRACT

An imaging device has: a video camera that takes a video of an imaging object; a camera holder that supports the video camera at a position of imaging the imaging object; an output module that outputs the video taken by the video camera; and an image processing module configured to superimpose a predetermined figure at a reference point of expanded display or contracted display in the video output by the output module. The imaging device of this arrangement enables easy adjustment of an expansion display area of an imaging object in the course of outputting a video signal representing a taken video of the imaging object to an external device.

### CLAIM OF PRIORITY

The present application claims the priority based on Japanese Patent Application No. 2007-143595 filed on May 30, 2007, the disclosure of which is hereby incorporated by reference in its entirety.

### BACKGROUND

1. Technical Field

The present invention relates to an imaging device configured to take a video of an imaging object and output a video signal representing the video of the imaging object to an external device.

2. Related Art

Presentation devices have been known as one type of imaging device structured to take a video of an imaging object, for example, a presentation material, with a video camera and output a video signal representing the taken video to a monitor. In the case of expanded display of the presentation material by the presentation device, a reference point of the expanded display is generally located on a center axis of a lens attached to the video camera. Even a slight positional deviation of an expansion display area of the presentation material from the center axis of the lens causes the deviation to be significantly observed in the resulting expanded display with an increase in expansion rate.

As a countermeasure against this problem, a presentation device disclosed in JP-A-H09-181944 has a function of irradiating a center position of an imaging area of a video camera with a high-intensity LED. This function of the presentation device enables adequate expanded display of the user's desired expansion display area of the presentation material by simply adjusting the expansion display area to the position irradiated with the high-intensity LED.

In a presentation made with the presentation device, the user generally explains the presentation material with viewing the displayed video of the presentation material on the monitor. The above proposed function of the prior art presentation device requires the user to move the eyes from the display on the monitor to the presentation material irradiated with the high-intensity LED for the positional adjustment of the expansion display area of the presentation material. This may interfere with the smooth progress of the presentation.

### SUMMARY

There would thus be a demand for enabling easy adjustment of an expansion display area of an imaging object in an imaging device configured to output a video signal representing a taken video of the imaging object to an external device.

The present invention accomplishes at least part of the demands mentioned above and the other relevant demands by the following configuration. According to one aspect, the invention pertains to an imaging device having a zoom function for expanded display or contracted display. The imaging device has: a video camera that takes a video of an imaging object; a camera holder that supports the video camera at a position of imaging the imaging object; an output module that outputs the video taken by the video camera; and an image processing module configured to superimpose a predetermined figure at a reference point of expanded display or contracted display by the zoom function in the video output by the output module.

The imaging device according to this aspect of the invention superimposes the predetermined figure at the reference point of expanded display or contracted display on the output video. This arrangement enables the user to simply refer to the superimposed display of the predetermined figure in the displayed image and readily adjust an expansion display area of the imaging object without moving the eyes from the displayed image to the imaging object. The reference point of expanded display or contracted display may be, for example, the center of the video taken by the video camera.

### BRIEF DESCRIPTION OF THE DRAWINGS

FIG. 1 shows a presentation device in use;

FIG. 2 is a rear view of the presentation device;

FIG. 3 shows the bottom face of a camera head in the presentation device;

FIG. 4 is a right side view of the presentation device;

FIG. 5 shows the schematic structure of an intermediate member in the presentation device;

FIG. 6 shows the camera head moved to its lower most position;

FIG. 7 shows the presentation device in its folded position;

FIG. 8 is a block diagram showing the electrical configuration of the presentation device;

FIG. 9 is a flowchart showing a zoom process; and

FIG. 10 shows a display example of a center mark.

### DESCRIPTION OF THE PREFERRED EMBODIMENT

In order to clarify the functions, the advantages, and the effects of the invention, one mode of carrying out the invention is described below in the following sequence as a preferred embodiment with reference to the accompanied drawings:
A. General Structure of Presentation Device
B. Electrical Configuration of Presentation Device
C. Zoom Process
D. Effects and Advantages
E. Other Aspects of the Invention

### A. General Structure of Presentation Device

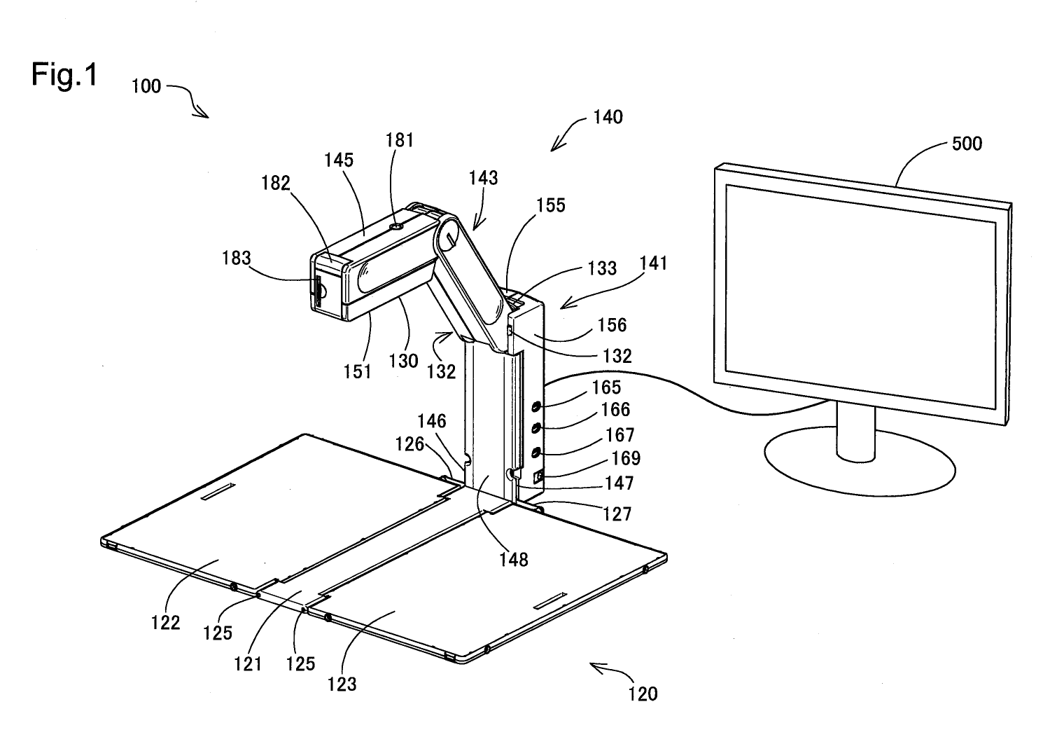

FIG. 1 shows a presentation device 100 in use as one embodiment of the imaging device according to the invention. As illustrated, the presentation device 100 includes a table 120 designed to keep a presentation material as an imaging object placed thereon and an arm assembly 140 equipped with a video camera 130 on its free end. A video of the presentation material taken by the presentation device 100 is displayed on a monitor device 500 connected to the presentation device 100.

The table 120 has a stationary member 121 fastened to a lower end of the arm assembly 140 and two extension members 122 and 123 supported in a rotatable manner on either ends of the stationary member 121. The stationary member 121 has a predetermined length of recesses formed on its opposed sides to receive therein mating projections protruded from the respective facing sides of the extension members 122 and 123. There is a through hole formed to pass through each engagement of the projection and the recess. Insertion of rotating shafts 125 into the respective through holes enables the extension members 122 and 123 to be rotated relative to the stationary member 121.

The two extension members 122 and 123 have joint bars 126 and 127 provided on their respective sides adjacent to the arm assembly 140 to restrict their extendable areas. The respective one ends of the joint bars 126 and 127 are screwed in a rotatable manner to the edges of the extension members 122 and 123. The respective other ends of the joint bars 126 and 127 are connected in a vertically movable manner via oil dampers to the inside of the arm assembly 140.

The arm assembly 140 includes a base unit 141 attached to the stationary member 121, an articulated intermediate member 143 connecting with the base unit 141 in a rotatable manner, and an articulated camera head 145 connecting with the intermediate member 143 in a rotatable manner.

The base unit 141 has a coupling member 148 mechanically coupled with the stationary member 121. Two grooves 146 and 147 are formed along a vertical axis of the coupling member 148 at its left and right ends on the side adjacent to the table 120. The respective other ends of the joint bars 126 and 127 are fitted in these grooves 146 and 147. The coupling member 148 is covered with a pair of splittable outer casings 155 and 156.

Three switches are provided on the left side face of the outer casing 156 to be aligned in the vertical direction. A lamp switch 165 at the upper-most position is operated to turn on and off an illumination lamp 151. A select switch 166 at the middle position is operated to select the source of an output video signal. A power switch 167 at the lower-most position is operated to turn on and off the presentation device 100. A power connector 169 is provided below the power switch 167 to receive connection of an external power unit.

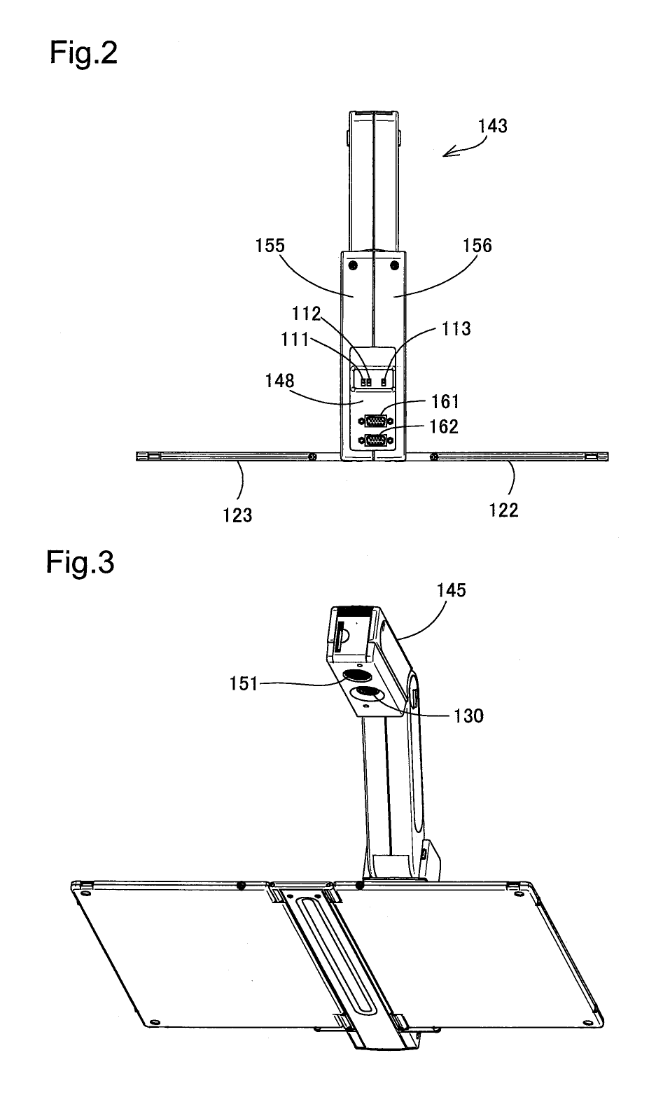

The select switch 166 is operated to change over the source of a video signal to be output to an RGB output terminal 162 (see FIG. 2) between a video signal taken by the video camera 130 of the presentation device 100 and a video signal input into an RGB input terminal 161 (see FIG. 2).

FIG. 2 is a rear view of the presentation device 100. The back face of the presentation device 100 has an opening defined by a recess of the outer casing 155 and a recess of the outer casing 156. The coupling member 148 is exposed to this opening. The RGB input terminal 161 for input of a video signal and the RGB output terminal 162 for output of a video signal are provided on the exposed coupling member 148. The coupling member 148 also has three switches 111, 112, and 113. The monitor device 500 shown in FIG. 1 is connected to the RGB output terminal 162.

The RGB output terminal 162 mainly outputs the video signal taken by the video camera 130. The RGB input terminal 161 inputs an external video signal from a personal computer or another external device. As mentioned previously, in response to the user's operation of the select switch 166 provided on the left side face of the base unit 141, the source of the video signal to be output to the RGB output terminal 162 is selected between the video signal taken by the video camera 130 of the presentation device 100 and the video signal input into the RGB input terminal 161.

Three switches 111, 112, and 113 are aligned in the horizontal direction. The switch 111 is a white balance switch to select either automatic adjustment of white balance in the video taken by the video camera 130 or a fixed value of white balance. The switch 112 is a flickerless switch to reduce a perceptible flicker in the video taken by the video camera 130 due to the influence of a luminescent lamp lit at a predetermined frequency. The switch 113 is a mode switch to select the mode of the output video signal between a text mode and a graphic mode. The text mode adjusts the gamma characteristic of the taken video signal to enhance the contrast and highlight the black and white. The graphic mode performs image processing operations on the video taken by the camera head 145 to attain the natural color reproduction.

As shown in FIG. 1, a shot button 181 is provided on the top face of the camera head 145. The shot button 181 is operated to extract or capture still images from the video taken by the video camera 130. The shot button 181 is located at a specified position to allow the user's easy index-finger or middle-finger operation when the camera head 145 is held by one hand. This position is, for example, in a range of 6 cm to 8 cm distant from the front face of the camera head 145. A shot button or a shutter button is generally provided on the top face of a casing for digital still cameras and film cameras. In the presentation device 100 of the embodiment, the shot button 181 is also located on the top face of the camera head 145. This positioning of the shot button 181 enables the user to be intuitionally informed of the function of the shot button 181.

A memory card slot 183 is provided on the front face of the camera head 145. The still images captured by the user's operations of the shot button 181 are recorded into a memory card inserted in the memory card slot 183. The captured still images may also be recorded into an internal memory of the presentation device 100. The captured still images may otherwise be recorded in an external hard disk connected to a USB connector 168 (described later).

The camera head 145 also has a luminescence element 182 as an indicator to indicate the operating condition of the presentation device 100. The luminescence element 182 includes a green LED for green light emission and a blue LED for blue light emission. Different operating conditions of the presentation device 100 are indicated by various combinations of these two color light emissions. For example, in response to the user's power-on operation of the presentation device 100, the luminescence element 182 is lit green. In response to the user's operation of operation buttons 194 and 195 (described later) for digital zooming, both the green LED and the blue LED are controlled to flash aqua-blue light on and off. In the structure of FIG. 1, the luminescence element 182 is located at a front corner of the camera head 145. The luminescence element 182 is, however, not restrictively located at this position but may be located at a rear edge of the camera head 145 connecting with the intermediate member 143 (that is, behind the shot button 181). In the structure of this embodiment, the luminescence element 182 uses LEDs to indicate the different operating conditions of the presentation device 100. The luminescence element 182 may alternatively be constructed by a liquid crystal panel or an organic EL panel for the same purpose.

FIG. 3 shows the bottom face of the camera head 145. As illustrated, the video camera 130 is set in the bottom face of the camera head 145. The illumination lamp 151 is also set in the same bottom face of the camera head 145 to irradiate the presentation material as the imaging object placed on the table 120. The illumination lamp 151 uses a white LED as a light source and has a diffuser plate to diffuse the light emitted from the white LED. The illumination lamp 151 is turned on and off in response to the user's operation of the lamp switch 165 provided on the left side face of the base unit 141.

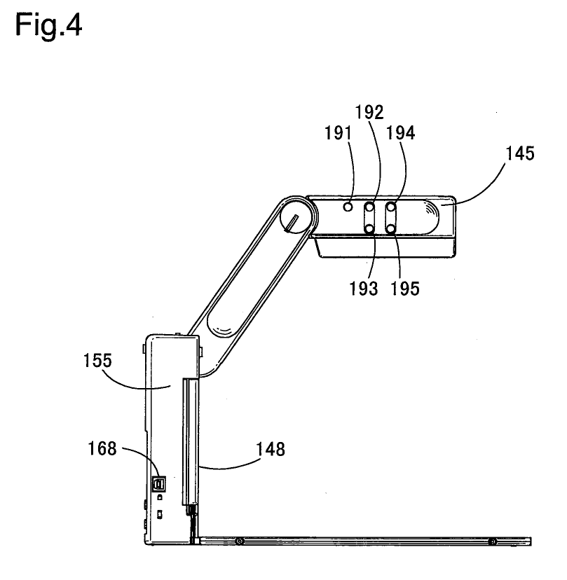

FIG. 4 is a right side view of the presentation device 100. As illustrated, five operation buttons 191 to 195 are provided on the right side face of the camera head 145. The operation button 191 is operated to playback images recorded in the memory card inserted in the memory card slot 183. The operation buttons 192 to 195 are operated to perform series of image processing on the video taken by the video camera 130. More specifically, the operation buttons 192 and 193 are used to adjust the brightness of the video taken by the video camera 130. The operation buttons 194 and 195 are used to adjust the zoom magnification of the video taken by the video camera 130. The zoom magnification adjusted by the operations of the operation buttons 194 and 195 represents a digital zoom magnification. In the description hereafter, the operation button 194 and the operation button 195 may be expressed respectively as ‘expand button 194’ and ‘contract button 195’. The operation buttons 191 to 195 are located at a specific position to allow the user's easy right thumb operations when the camera head 145 is held by the user's right hand. The operation button 191 for image playback is provided on the side face of the camera head 145 in the structure of this embodiment but may alternatively be provided on the top face of the camera head 145, that is, on the same plane as the shot button 181. The camera head 145 may additionally has other image processing buttons, for example, buttons for adjusting the saturation, the contrast, and the gamma value.

The USB connector 168 is provided on the right side face of the outer casing 155. A personal computer may be connected via a USB cable to the USB connector 168. The presentation device 100 outputs a video signal obtained by the video camera 130 as a digital signal via the USB connector 168 to the personal computer.

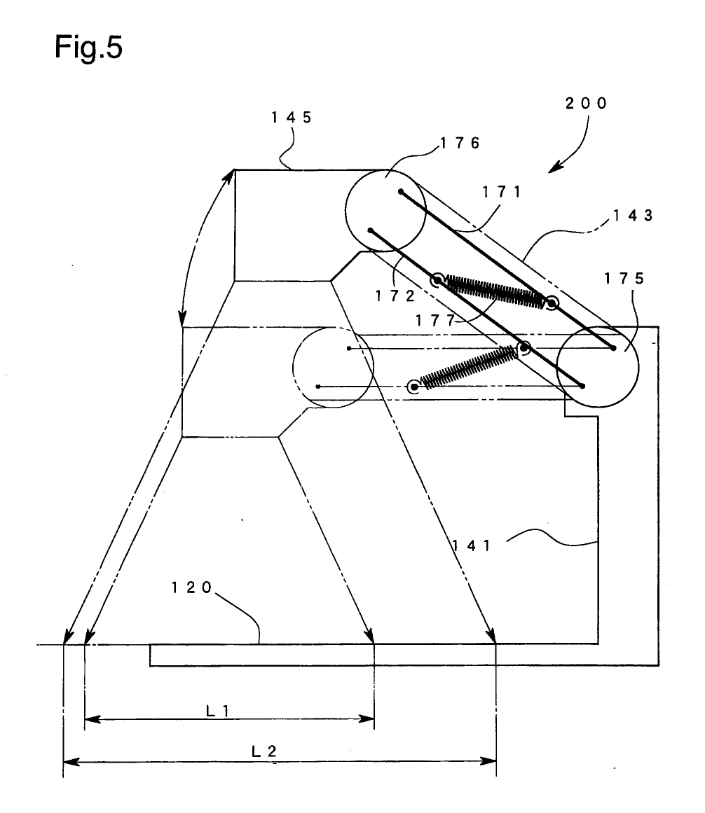

FIG. 5 shows the schematic structure of the intermediate member 143 connecting the base unit 141 with the camera head 145. A circular support member 175 formed as part of a link mechanism 200 (described later) is built in an upper portion of the base unit 141. The support member 175 links the base unit 141 with the intermediate member 143. As illustrated in FIG. 5, the intermediate member 143 has two built-in linkage members 171 and 172. The linkage members 171 and 172 are respectively attached in a rotatable manner to the support member 175 of the base unit 141 and to a support member 176 of the camera head 145. The support member 175 is not rotatable but is fastened to the base member 141, whereas the support member 176 is supported in a rotatable manner on a rotating shaft (not shown) set on the intermediate member 143. The camera head 145 is fixed to the support member 176 arranged to be rotatable relative to the intermediate member 143. There is a coil spring 177 spanned between the linkage member 171 and the linkage member 172. The coil spring 177 functions to decrease a load in the user's manual motion of the camera head 145.

When the user moves the camera head 145 held in one hand, the link mechanism 200 works in the following manner to keep the attitude of the camera head 145 and thereby the attitude of the video camera 130 relative to the table 120. In the user's downward motion of the camera head 145 from the position shown in FIG. 1, the two linkage members 171 and 172 are rotated about their respective one endpoints or their attachment positions on the support member 175. During this rotation, a positional relation between their respective other endpoints of the linkage members 171 and 172 (end points on the support member 176) is not changed but is maintained. The positional relation between their respective other endpoints of the linkage members 171 and 172 is maintained because the linkage members 171 and 172 and the support members 175 and 176 constitute a parallelogram. Fixation of one side of the parallelogram with motions of residual three sides causes an opposed side to keep the parallelism relative to the fixed side. The camera head 145 fastened to the support member 176 is accordingly kept at the same attitude before and after the motion of the camera head 145. The absolute position of the support member 176 is changed with a motion of the camera head 145 to move the intermediate member 143. The support member 176 is thus rotated clockwise relative to the rotating shaft on the intermediate member 143.

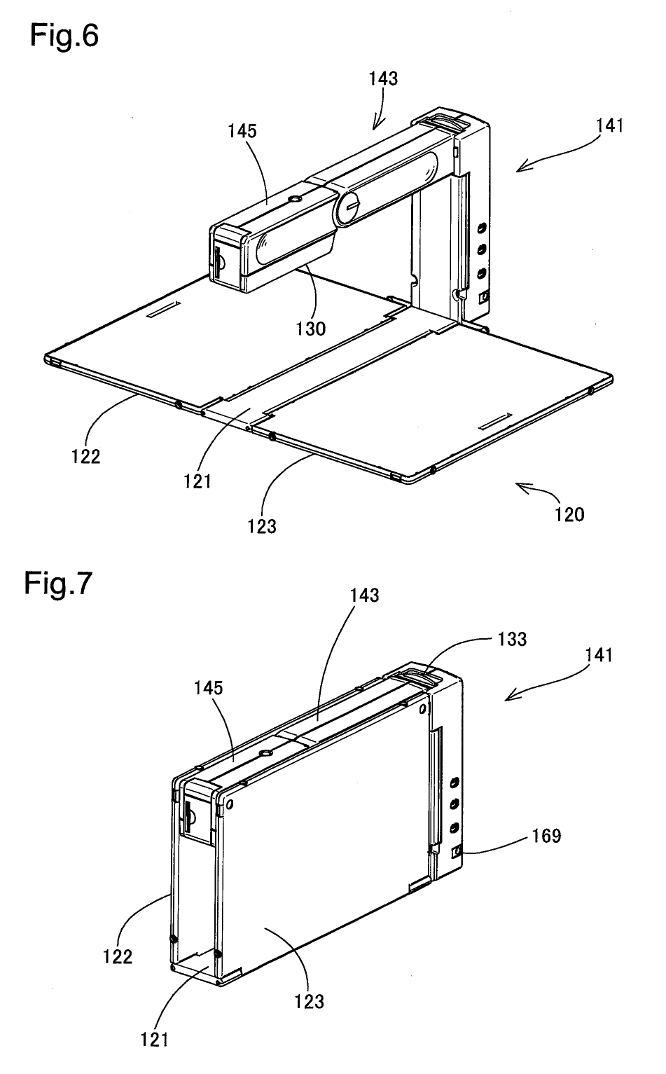

FIG. 6 shows the camera head 145 moved to its lower most position. As illustrated, at the lower most position of the camera head 145, the intermediate member 143 and the camera head 145 are substantially aligned, and the intermediate member 143 is located substantially perpendicular to the base unit 141. In this embodiment, the video camera 130 uses a single focus lens and accordingly enables the video of the presentation material as the imaging object placed on the table 120 to be clearly taken even at the lower most position shown in FIG. 6. The imaging area of the video camera 130 is narrower at the lower most position shown in FIG. 6, compared with the imaging area at the position shown in FIG. 1. A change of the imaging area according to the positional relation of the video camera 130 to the table 120 is schematically shown as imaging areas L1 and L2 in FIG. 5. As shown in FIG. 5, the imaging area is expanded and contracted with the positional change of the single focus lens-equipped video camera 130.

FIG. 7 shows the presentation device 100 in its folded position. The presentation device 100 is folded away at the position of the camera head 145 closest to the table 120 (that is, the position shown in FIG. 6). The procedure of folding away the presentation device 100 moves down the camera head 145 to the lower most position or the closest position to the table 120 as shown in FIG. 6 and subsequently lifts up the extension members 122 and 123 of the table 120 to the substantially vertical orientations. In this state, the respective free sides of the extension members 122 and 123 opposite to their fixation sides to the fixation member 121 are substantially aligned with the top faces of the intermediate member 143 and the camera head 145 as shown in FIG. 7.

As shown in FIG. 1, lock mechanisms 132 are provided in upper ends of the outer casing 155 and 156 on the side facing the table 120 to keep the extension members 122 and 123 in their folded positions. When the extension members 122 and 123 are lifted up, the rear recesses of the extension members 122 and 123 are fit in and engaged with the mating lock mechanisms 132. The locking of the lock mechanisms 132 prevents the extension members 122 and 123 from being unexpectedly unfolded by their own weights. In response to the user's operation of an unlock lever 133, the lock mechanisms 132 are drawn into the outer casing 155 and 156. The unlocking of the lock mechanisms 132 allows the extension members 122 and 123 to be unfolded by their own weights. The extension members 122 and 123 are linked with the inside of the arm assembly 140 by means of the oil dampers as mentioned above and are thus slowly extended.

In the folded position of FIG. 7, the presentation device 100 of the embodiment is a substantially rectangular parallelepiped, which occupies an area of less than half the area of the table 120 and a width of only slightly wider than the width of the base unit 141 (by double the thickness of the table 120). The space occupied by the presentation device 100 in the folded state is thus significantly smaller than the space required for the presentation device 100 in use with extension of the table 120 for the presentation material. This arrangement desirably attains the size reduction of the presentation device 100 in the folded state and remarkably improves the portability of the presentation device 100. The presentation device 100 is set in its service position by simply unfolding and extending both the extension members 122 and 123 to the horizontal orientations and pulling up the camera head 145. The presentation device 100 can thus be readily transformed from its folded position to its service position. In use, the extension of the table 120 ensures a sufficiently wide area for placing the presentation material thereon. A power unit 220 to be connected to the power connector 169 may be designed to have a width substantially equal the width of the base unit 141. The power unit 220 can then be placed in an inner space defined by the extension members 122 and 123 and the base unit 141 in the folded position of the presentation device 100.

### B. Electrical Configuration of Presentation Device

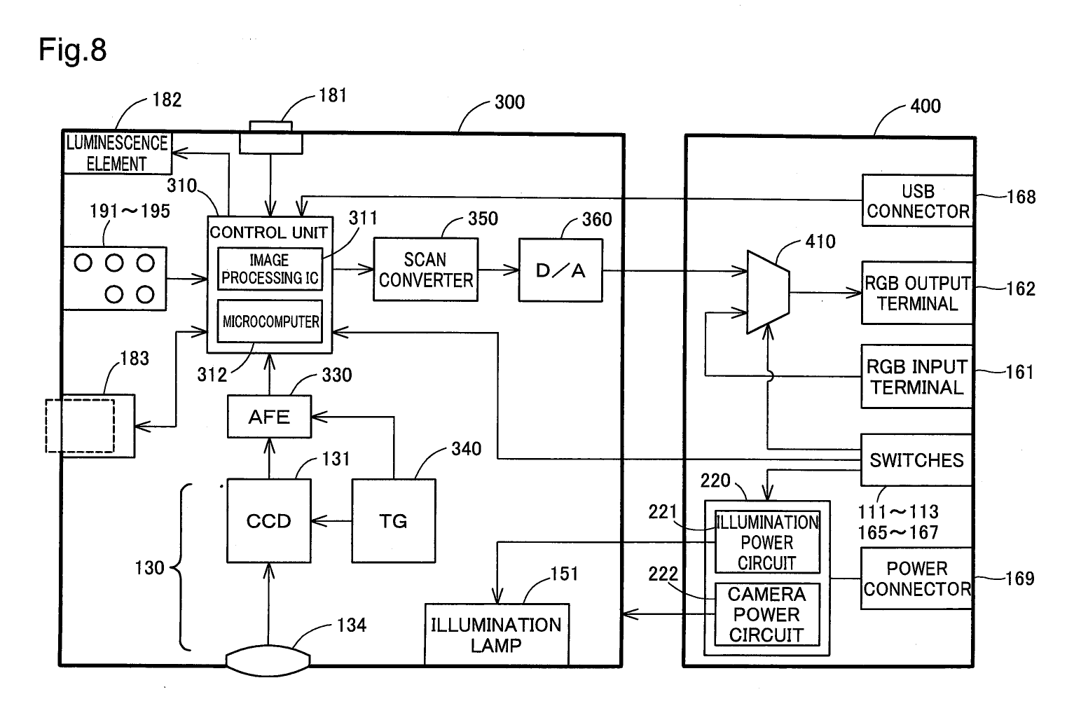

FIG. 8 is a block diagram showing the electrical configuration of the presentation device 100. As illustrated, the presentation device 100 of the embodiment includes a camera control board 300 placed inside the camera head 145 and a base board 400 placed in the base unit 141. The camera control board 300 and the base board 400 are interconnected via a predetermined number of cables laid out in the intermediate member 143. The presentation device 100 of the embodiment uses one camera control board 300 and one base board 400. These numbers are, however, neither essential nor restrictive, and the presentation device may include an adequate number of multiple camera control boards and/or an adequate number of multiple base boards according to the requirements.

As shown in FIG. 8, a control unit 310, the video camera 130, an AFE (analog front end) circuit 330, a timing generator 340, a scan converter 350, and a D-A conversion circuit 360 are mounted on the camera control board 300. The camera control board 300 is connected with the shot button 181, the operation buttons 191 to 195, the memory card slot 183, the illumination lamp 151, and the luminescence element 182.

The video camera 130 includes a CCD (charge coupled device) 131 and a single focus lens 134. The CCD 131 is an image sensor configured to convert light focused by the single focus lens 134 into an analog electric signal. The AFE circuit 330 is configured to input the analog signal from the CCD 131 and convert the input analog signal into a digital signal. The digital signal generated by the A-D conversion of the AFE circuit 330 is input into the control unit 310. Reference pulses are generated by the timing generator 340 and are input into the CCD 131 and the AFE circuit 330. The CCD used as the image sensor in this embodiment may be replaced with a CMOS sensor.

The control unit 310 includes an image processing IC (integrated circuit) 311 and a microcomputer 312. The image processing IC 311 performs required image processing operations on the digital signal obtained by A-D conversion of the video signal taken by the video camera 130 and input from the AFE circuit 330. The image processing operations performed by the image processing IC 311 include adjustment of the digital zoom magnification in response to the user's operations of the operation buttons 194 and 195 and adjustment of white balance in response to the user's operation of the switch 111. In response to the user's depression of the expand button 194, the control unit 310 displays a mark representing a reference point of expansion/contraction on the center of the monitor device 500 for 4 seconds (hereafter this mark is referred to as center mark). The detailed procedure of displaying the center mark will be described later.

The microcomputer 312 includes a CPU, a ROM, and a memory. The CPU executes a program recorded in the ROM and loaded onto the memory to enable the microcomputer 312 to transmit the user's operations of the operation buttons 191 to 195 and the switches 111 to 113 to the image processing IC 311. The microcomputer 312 also controls on and off the LEDs included in the luminescence element 181 according to the operating condition of the presentation device 100.

The image processing IC 311 of this embodiment controls input and output of images from and into a memory card set in the memory card slot 183. In response to reception of a signal representing the user's depression of the shot button 181 from the microcomputer 312, the image processing IC 311 captures one frame of still images from the video signal input from the AFE circuit 330. The captured still images are recorded in a predetermined file format (for example, JPEG format or bitmap format) into a memory card inserted in the memory card slot 183. As mentioned above, the image processing IC 311 of this embodiment records the still images into the memory card in response to the user's depression of the shot button 181. The image processing IC 311 may alternatively record at least part of the video taken by the video camera 130 as a moving picture into the memory card. In one arrangement of such moving picture recording, the video taken during the user's depression of the shot button 181 may be recorded as a moving picture into the memory card. In another arrangement, the video taken in a time period between the user's one depression of the shot button 181 and the user's subsequent depression of the shot button 181 may be recorded as a moving picture into the memory card. The file format of the moving picture recorded in the memory card may be, for example, MPEG 1, 2, 4 or H.264. In the case of recording a moving picture, a microphone may be incorporated in the camera head 145 or another suitable part for simultaneous voice or audio recording.

In response to detection of the user's operation of the operation button 191 via the microcomputer 312, the image processing IC 311 reads still image data from the memory card and outputs the read still image data as a video signal. The still images to be read from the memory card are selectable by the user's operations of the operation buttons 192 and 193. In response to the user's one depression of the operation button 191, the display mode of the presentation device 100 is switched over to a still image reproduction mode. In the still image reproduction mode, the operation buttons 192 and 193 work to change over the display of the still images. In response to the user's subsequent depression of the operation button 191, the display mode of the presentation device 100 is returned to an ordinary mode for displaying the video taken by the video camera 130. In the ordinary mode, the operation buttons 192 and 193 work to adjust the brightness of the output video.

After the required image processing operations by the image processing IC 311 in the control unit 310, the processed video signal is output to the scan converter 350. The scan converter 350 converts a vertical synchronizing frequency of the input video signal into a predetermined frequency (for example, 60 Hz) and outputs the video signal of the predetermined frequency to the D-A conversion circuit 360. The D-A conversion circuit 360 converts the digital video signal input from the scan converter 350 into an analog RGB signal. The analog RGB signal generated by the D-A conversion circuit 360 is transmitted through a predetermined cable laid out in the intermediate member 143 and is input into a selection circuit 410 of the base board 400.

As shown in FIG. 8, the base board 400 includes the selection circuit 410 and the power unit 220. The USB connector 168, the power connector 169, the RGB input terminal 161, the RGB output terminal 162, and the various switches 111 to 113 and 165 to 167 are also mounted on the base board 400.

The selection circuit 410 inputs the analog RGB signal from the D-A conversion circuit 360 of the camera control board 300, as well as the analog RGB signal from the RGB input terminal 161. The selection circuit 410 is connected with the select switch 166 provided in the base unit 141. In response to the user's operation of the select switch 166, the analog RGB signal to be output is selected between the two input analog RGB signals.

The power unit 220 is equipped with an illumination power circuit 221 and a camera power circuit 222. The illumination power circuit 221 receives supply of electric power from the power connector 169 and generates electric power to be supplied to the illumination lamp 151. The camera power circuit 222 receives supply of electric power from the power connector 169 and generates electric power to be supplied to the whole camera control board 300. The electric power generated by the illumination power circuit 221 is transmitted through a predetermined cable laid out in the intermediate member 143 and is supplied to the illumination lamp 151 mounted on the camera control board 300. The illumination power circuit 221 is connected with the lamp switch 165 provided in the base unit 141. The power supply to the illumination lamp 151 is on and off in response to the user's operation of the lamp switch 165. The power unit 220 is also connected with the power switch 167 provided in the base unit 141. The power supply to the presentation device 100 is on and off in response to the user's operation of the power switch 167.

An USB signal input into the USB connector 168 is transmitted through the base board 400 and a predetermined cable laid out in the intermediate member 143 and is input into the control unit 310 (more specifically into the image processing IC 311) mounted on the camera control board 300. Namely the base board 400 has a function of relaying the USB signal input into the USB connector 168 to the camera control board 300. Such configuration does not require the USB connector 168 located in the movable camera head 145 and thus simplifies the layout of a USB cable for connection with a personal computer.

Among the various switches 111 to 113 and 165 to 167 mounted on the base board 400, the lamp switch 165, the select switch 166, and the power switch 167 are respectively connected to the illumination power circuit 221, the selection circuit 410, and the power unit 220 as explained above. The white balance switch 111, the flickerless switch 112, and the mode switch 113 are connected to the control unit 310 mounted on the camera control board 300 via a predetermined cable laid out in the intermediate member 143. The switches 111 to 113 related to the image processing operations performed by the image processing IC 311 are not frequently used and are thus mounted on the base board 400 placed in the base unit 141. The camera head 145 held by the user's hand and operated by the user are equipped with only the frequently used switches. This arrangement remarkably improves the operation ability of the presentation device 100.

In this embodiment, the electrical configuration of the presentation device 100 is divided into the two boards, the camera control board 300 and the base board 400. All the circuit elements may alternatively be mounted on the camera control board 300. Some of the circuit elements mounted on the camera control board 300 explained above may be located in the intermediate member 143, the base unit 141, or the table 120 according to the requirements.

### C. Zoom Process

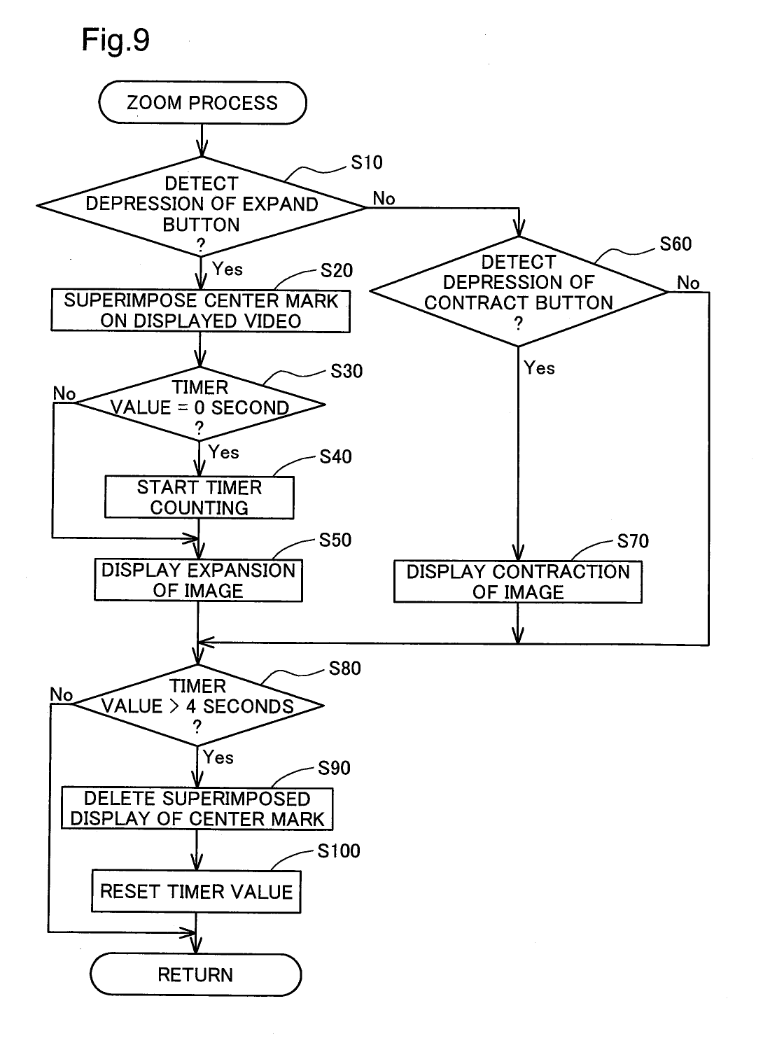

FIG. 9 is a flowchart showing a zoom process executed by the control unit 310. The zoom process is repeatedly performed after each power-on operation of the presentation device 100. A timer value used in the zoom process is set to an initial value ‘0 second’ on the start of the zoom process.

On the start of the zoom process, the control unit 310 first detects the user's depression of the expand button 194 (step S10). In response to detection of the user's depression of the expand button 194 (step S10: yes), the control unit 310 superimposes a center mark CM at the center of a video taken by the video camera 130 and displayed on the monitor device 500 (step S20).

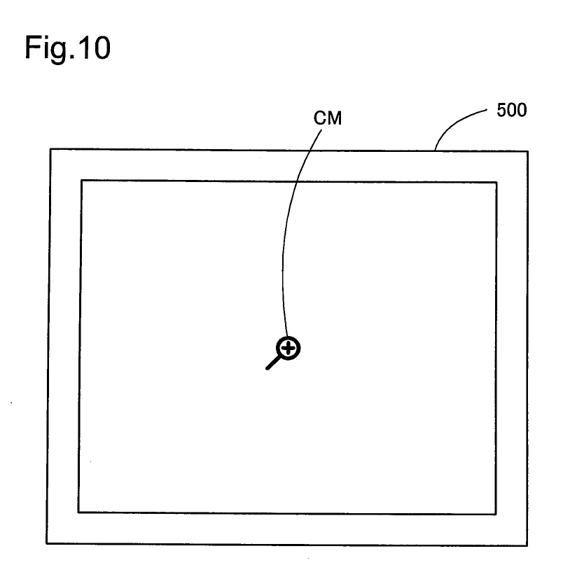

FIG. 10 shows a display example of the center mark CM. In the illustrated example, an icon representing a magnifying glass with a “+” sign is displayed as the center mark CM. The display of this icon readily informs the user of expansion of the display. The display of the center mark CM is, however, not restricted to this icon. For example, animation of a rectangular figure expanding from the screen center toward the screen edge may be adopted for the same purpose.

After the superimposed display of the center mark CM at step S20, the control unit 310 determines whether the current timer value is equal to ‘0 second’ (step S30). The timer value is a parameter for counting a display time of the center mark CM. When the current timer value is ‘0 second’ (step S30: yes), the control unit 310 starts timer counting (step S40). When the current timer value is not ‘0 second’ (step S30: no), on the other hand, the control unit 310 skips the processing of step S40. After the start of timer counting at step S40, the timer value is automatically counted up. The control unit 310 then displays expansion of the image taken by the video camera 130 (step S50). In the case of the user's further operation of the expand button 194 during display of an expanded image, the expansion rate of the display is increased. The upper limit of the expansion rate may be, for example, 800%.

In the case of no detection of the user's depression of the expand button 194 (step S10: no), the control unit 310 subsequently detects the user's depression of the contract button 195 (step S60). In response to the user's depression of the contract button 195 (step S60: yes), the control unit 310 displays contraction of the image taken by the video camera 130 (step S70). In the case of the user's further operation of the contract button 195 during display of a contracted image, the expansion rate of the display is decreased. The lower limit of the expansion rate is 100% (the same magnification as the original magnification of the image). In the case of no detection of the user's depression of the contract button 195 (step S60: no), the control unit 310 skips the processing of step S70.

The control unit 310 subsequently determines whether the current timer value exceeds ‘4 seconds’ (step S80). The current timer value of greater than ‘4 seconds’ (step S80: yes) means the superimposed display of the center mark CM for at least 4 seconds. In this case, the control unit 310 deletes the center mark CM displayed at step S20 (step S90) and resets the timer value to ‘0 second’ (step S100).

The current timer value of not greater than ‘4 seconds’ (step S80: no) means either no display of the center mark CM or no elapse of 4 seconds since the start of the superimposed display of the center mark CM. The control unit 310 accordingly skips the processing of steps S90 and S100. In this case, the display of the center mark CM is continued or no display of the center mark CM is continued.

### D. Effects and Advantages

The presentation device 100 of the embodiment performs the zoom process as described above and superimposes the center mark CM on the video displayed on the monitor device 500 in response to detection of the user's depression of the expand button 194. The user refers to the video of the presentation material displayed on the monitor device 500 and the position of the superimposed display of the center mark CM to readily adjust the position of a desired part of the presentation material as an expansion object to the center of the displayed video as the reference point of expansion. This arrangement does not require the user to move the user's eyes to the presentation material for the positional adjustment of the expansion object. The user can thus adjust the position of the presentation material for expanded display without interrupting the user's presentation made with the presentation device 100.

Once the user presses the expand button 194, the zoom process keeps the superimposed display of the center mark CM for 4 seconds, irrespective of the user's subsequent operation of the expand button 194 or the contract button 195. The user can thus readily adjust the position of the presentation material for expanded display and the zoom magnification within this time period of 4 seconds. In this embodiment, the display time of the center mark CM is set to 4 seconds since the user's zoom operation is generally completed within 4 seconds. The display time is, however, not restricted to 4 seconds but may be set to an arbitrary time period, for example, 3 seconds or 5 seconds. One applicable structure enables the user to arbitrarily change the setting of the display time.

In this embodiment, the center mark CM is not displayed in response to the user's depression of the contract button 195. This is because the contracted display does not move a desired part of the presentation material as a contraction object to the screen edge. This arrangement simplifies the processing and ensures the smooth progress of the user's presentation.

The embodiment discussed above is to be considered in all aspects as illustrative and not restrictive. There may be many modifications, changes, aspects and alterations without departing from the scope or spirit of the main characteristics of the present invention.

For example, the zoom process of the embodiment superimposes the center mark CM on the displayed video for digital zooming. The center mark CM may also be superimposed on the displayed video for optical zooming by the motion of the camera head 145. The optical zooming may be detected according to a positive or negative value output from an acceleration sensor attached to the intermediate member 143 or the camera head 145.

In a presentation device having the function of optical zooming in response to the user's operation of a preset operation button or remote control, the center mark CM may be superimposed on the video displayed on the monitor device 500 for optical zooming.

In the presentation device 100 of the embodiment, the control unit 310 superimposes the center mark CM on the display of the video taken by the camera head 145. In one modification, a predetermined superimpose circuit may be provided to superimpose the center mark CM on the video signal output from the scan converter 350 or on the video signal output from the D-A conversion circuit 360 shown in FIG. 8.

The zoom process of the embodiment superimposes the center mark CM at the center of the displayed video. One modification may allow the center mark CM to be moved arbitrarily by the user's preset operation. In this modification, the reference point of digital zooming is shifted to the moved position of the center mark CM. This modified arrangement enables expanded display of any arbitrary area in the video.

The presentation device 100 of the embodiment uses the two buttons, the expand button 194 and the contract button 195, for digital zooming. The digital zooming operation is, however, not restricted to this structure but may be performed with any other suitable interface, for example, a jog dial, a joy stick, or an adjustment knob.

The presentation device 100 of the embodiment basically attains expansion and contraction of the displayed video of a presentation material as the imaging object by moving up and down the camera head 145. The presentation device 100 also has a function of digital zooming in response to the user's operations of the expand button 194 and the contract button 195. The digital zooming operation, however, lowers the picture quality of the displayed video and is thus preferably performed with the camera head 145 moved down to its lower most position (the position shown in FIG. 6). The control unit 310 may perform additional control to urge the user to perform the digital zooming operation with moving down the camera head 145 to its lower most position. In this modification, the presentation device 100 is equipped with a sensor to detect the downward motion of the camera head 145 to its lowermost position. Only in the case of detection of the downward motion of the camera head 145 to its lower most position, the control allows the user to perform the digital zooming operation with the operation buttons 194 and 195. When the user operates the operation button 194 or 195 at the position of the camera head 145 other than its lower most position, the control may superimpose a message like ‘please move down the camera to the lower most position before digital zooming’ on the displayed video. In another modified structure, the arm assembly 140 may be equipped with an angle sensor. The control may allow the user to perform the digital zooming operation in response to detection of a rotation of the intermediate member 143 within a preset angle range (for example, an angle range of +20 degrees from the horizontal axis) as well as detection of the downward motion of the camera head 145 to its lower most position.

### E. Other Aspects of the Invention

In one preferable application of the imaging device of the invention, the image processing module superimposes the predetermined figure on the output video at a start of expanded display by the zoom function. In this application, no superimposed display of the predetermined figure is given on the output video when the expanded display is not required. This arrangement does not narrow the displayed area of the video in the ordinary use.

In one preferable structure of the imaging device of this application, the image processing module keeps the superimposition of the predetermined figure on the output video for a preset time period since the start of expanded display by the zoom function. The superimposed display of the predetermined figure is deleted after elapse of the preset time period since the start of expanded display. This arrangement does not require the user any extra operation for deleting the superimposed display of the predetermined figure and thereby enhances the user's convenience.

In the imaging device of this embodiment, the image processing module may keep the superimposition of the predetermined figure on the output video for the preset time period even at a start of contracted display by the zoom function within the preset time period. The superimposed display of the predetermined figure is kept for the preset time period even in the event of contracted display. This arrangement enables the user to adjust the position of the imaging object and the expansion rate within the preset time period by referring to the superimposed display of the predetermined figure representing the reference point of expanded display or contracted display.

In another preferable application of the imaging device, the imaging device further comprises a digital zoom unit that inputs a video signal from the video camera and expands or contracts a video image represented by the video signal. This arrangement enables the superimposed display of the predetermined figure during a digital zooming operation.

In one preferable embodiment according to the above aspect of the invention, the imaging device further has a table that places the imaging object thereon. The camera holder has: a camera head equipped with the video camera on its bottom face; an arm assembly located above the table to support the camera head in a movable manner; and an attitude maintaining mechanism integrated with the arm assembly to support a relative attitude of the camera head to the table during a motion of the camera head. The camera head is equipped with a zoom button which activates the zoom function.

This arrangement enables the user to readily superimpose the predetermined figure on the output video by simply operating the zoom button mounted on the camera head.

What is claimed is:

1. An imaging device having a zoom function for expanded display or contracted display, the imaging device comprising:
a video camera that takes a video of an imaging object;
a camera holder that supports the video camera at a position of imaging the imaging object;
an output module that outputs the video taken by the video camera; and
an image processing module configured to superimpose a predetermined figure at a reference point of expanded display or contracted display by the zoom function in the video output by the output module.

2. The imaging device in accordance with claim 1, wherein the image processing module superimposes the predetermined figure on the output video at a start of expanded display by the zoom function.

3. The imaging device in accordance with claim 2, wherein the image processing module keeps the superimposition of the predetermined figure on the output video for a preset time period since the start of expanded display by the zoom function.

4. The imaging device in accordance with claim 3, wherein the image processing module keeps the superimposition of the predetermined figure on the output video for the preset time period even at a start of contracted display by the zoom function within the preset time period.

5. The imaging device in accordance with claim 1, the imaging device further comprising:
a digital zoom unit that inputs a video signal from the video camera and expands or contracts a video image represented by the video signal.

6. The imaging device in accordance with claim 1, wherein the reference point is a center point of the video.

7. The imaging device in accordance with claim 1, the imaging device further comprising:
a table that places the imaging object thereon,
wherein the camera holder has:
a camera head equipped with the video camera on its bottom face;
an arm assembly located above the table to support the camera head in a movable manner; and
an attitude maintaining mechanism integrated with the arm assembly to support a relative attitude of the camera head to the table during a motion of the camera head,
the camera head being equipped with a zoom button which activates the zoom function.
